(19) United States
(12) Patent Application Publication
(10) Pub. No.: US 2011/0217219 A1
(43) Pub. Date: Sep. 8, 2011

(54) SCRUBBING SOLUTION CONSISTING OF AQUEOUS AMMONIA SOLUTION AMINES FOR THE SCRUBBING OF GAS AND USE OF SUCH SOLUTION

(75) Inventor: Johannes Menzel, Waltrop (DE)

(73) Assignee: UHDE GMBH, Dortmund (DE)

(21) Appl. No.: 13/125,330

(22) PCT Filed: Oct. 15, 2009
(86) PCT No.: PCT/EP09/07412

§ 371 Date: Apr. 21, 2011

(30) Foreign Application Priority Data
Oct. 21, 2008 (DE) 10 2008 052 612.6

(51) Int. Cl. B01D 53/40; C09K 3/00; B01D 53/52; B01D 53/62; B01D 53/54; B01D 53/48; B01D 53/50

(52) U.S. Cl. 423/228; 423/210; 252/190; 423/236; 423/242.7

(57) ABSTRACT

The invention relates to a process using a solvent combination for the gas scrubbing of industrial gases in order to separate acid gases, particularly including carbon dioxide and hydrogen sulphide. The inventive solvent combination consists of a solution of amines in water, said solution containing ammonia for improving the absorption of CO₂. The group of primary and secondary amines includes all types of amines with one or two substituents. Particularly suitable as constituent of the inventive solvent combination is piperazine and piperazine derivatives.

The invention relates to a scrubbing solution for the separation of acid gases from industrial gases and from flue gases by aqueous ammonia solutions and by the addition of amines dissolved therein. Acid gases preferably to be separated are hydrogen sulphide, carbon dioxide, hydrocyanic acid and sulphur oxides (SOₓ). Industrial gases which frequently require separation and can be treated by the inventive process are coke oven gas, synthesis gas, natural gas, carbon monoxide and hydrogen. The inventive gas scrubbing takes place in devices according to prior art.

The removal of acid gases from industrial gases is a process frequently run. Examples of gases subjected to such a process are synthesis gases and coke oven gases. For the re-use of these gases it is frequently necessary to remove the interfering acid gases contained. Aqueous solutions of organic bases, such as alkanol amines, are frequently used for the removal of acid gases on an industrial scale. As the acid gases are dissolved, ionic products form from the base and the acid gas constituents. The absorption agent can be regenerated by heating or by reducing the pressure, the ionic products being reconverted into acid gases and the acid gases being removed by steam depending on the requirements. After the regeneration process the absorption agent can be re-used.

In the absorption of hydrogen sulphide from industrial gases, part of the carbon dioxide frequently also contained in the gases is co-absorbed. However, the absorbed constituent amount of this gas is considerably less than the constituent amount of the hydrogen sulphide. The reason for this is the generally poor mass transfer of the carbon dioxide into the scrubbing solution. When scrubbing gases, the carbon dioxide reacts to form hydrogen carbonate which is bound in ionic form in the scrubbing solution after the reaction. The low reaction velocity of the carbon dioxide into the ionic form causes the reduced constituent amount of the carbon dioxide compared to that of hydrogen sulphide.

However, when scrubbing acid gas it is frequently desired to considerably increase the constituent amount of the absorbed carbon dioxide, thus much less equipment being required. In this way, it is managed that a considerably larger portion of acid gases is removed from industrial gases by scrubbing in one process step.

DE 102004011429 A1 describes a process for the absorption of acid gases. Described is a process for the removal of carbon dioxide from a gas flow with a very low carbon dioxide partial pressure, in which the gas flow is brought into contact with a liquid absorption agent which contains an aqueous solution of an amine compound with at least two tertiary amino groups in the molecule and an activator selected from the primary and secondary amines. With regard to the performance of absorption reactions there is still a need to further increase the absorption amount of acid gases and particularly of carbon dioxide in relation to the amount of the solvent used.

GB 1464439 A describes a process for the removal of acid gas constituents from industrial gases and particularly from a coke oven gas, a synthesis gas or natural gas. The acid gases are absorbed by an alkanol amine solution circulated in a loop, such that the solvent absorbs the acid gas and then desorbs it in the next cycle step, for example, by heating. The teaching describes a decomposition of the absorbed solvent by the formation of thermally stable thiocyanates. For stabilising purposes, ammonia or ammonium salts are therefore added to the solvent and react with the thiocyanates formed while the gas constituents are being restored. An addition of ammonia to an amine-containing solution with the aim of improving the absorbability of acid gases, in particular of CO₂, is not described.

The solvent used should be as stable as possible, in particular stable against oxygen and not least also as cost-efficient as possible. Solvent losses occur on account of the decomposition of the amines by a reaction with the oxygen contained in the flue gases or with the sulphur oxides or nitric oxides contained in the flue gas. Many amine-based scrubbing agents have high procurement costs on account of which solvent losses lead to an increase in the running costs of the process during operation. The used solvent should also require as few equipment items for mass transfer as possible, in particular in the scrubbing column.

It is therefore the objective of the invention to provide an improved solvent or an improved solvent combination which absorbs a considerably higher amount of acid gases from industrial gases. Industrial gases which frequently require treatment and can be treated by the inventive process are coke oven gas, synthesis gas, natural gas, lower alkanes and alkenes and hydrogen. The improved solvent should be of as low cost as possible and be stable under the applied conditions. The constituents contained in the solvent combination should be oxygen-stable to ensure a sufficiently long service life in the gas scrubber. Moreover, the inventive solvent combination should considerably improve the mass transfer of the carbon dioxide to be removed. There should be a low need for replenishment of the costly amine constituent and a low number of devices required for mass transfer.

The invention achieves the objective by a solvent combination from an amine and an aqueous ammonia solution, the used amine particularly being a primary amine or a secondary amine. Piperazine is particularly suitable as amine constituent. This amine additive gives a considerably improved carbon dioxide absorption even at atmospheric pressure conditions, such scrubbing being particularly suitable for the removal of carbon dioxide from flue gases. Using ammonia as the main constituent for binding the carbon dioxide will considerably improve the mass transfer of this gas and significantly reduce the costs of the running process.

Not only single primary amines but also secondary or cyclic amines are suitable as amine additives. For some cases tertiary amines can also be suited. In general language use the amine constituent in gas scrubbing solutions is also termed activator. Piperazine is particularly preferred as activator constituent. However, it is also possible to use alkyl amines, dialkyl amines or diaryl amines. The ammonia contained in the solvent facilitates a higher absorption capacity for carbon dioxide as compared to that of pure amine solutions such that the removal of carbon dioxide can be carried out at lower cycle flow rates and thus with a correspondingly lower regeneration energy demand. Likewise lower are the amount required as exchange solvent and the number of equipment items required for the solvent exchange.

Particularly claimed is a scrubbing solution for the desulphurisation of acid gases from industrial gases, the gas flow being brought into contact with a liquid absorption agent in a suitable scrubbing device, the liquid absorption agent being an aqueous solution containing ammonia and at least one amine, and the amine not containing any hydroxy-alkyl substituents in the molecule. Claim is also laid to the use of such a scrubbing solution in a gas scrubbing process for the absorption of acid gases and particularly carbon dioxide from industrial gases.

The amine can be a primary or a secondary amine. For some cases tertiary amines can also be suited. The substituents on the amine can be of any type. The primary amine can have the general formula H₂N—R^{a}, R^{a} being selected from alkyl groups, aryl groups or aryl alkyl groups. Examples of suitable primary amines are n-propyl amine, iso-propyl amine or phenyl amine. The boiling point of the primary amine should preferably be above ambient temperature in order to ensure a technically simple gas scrubbing process.

The secondary amine can also be of any type. The substituents of the secondary amine compound can be of any type. The amine can, for example, have the general formula R^{a}—N(H)—R^{b}, with R^{a} and R^{b} being selected independently of each other from the alkyl groups, aryl groups or aryl alkyl groups. Examples of suitable secondary amines are diethyl amine, di-n-propyl amine or diphenyl amine. The boiling point of the primary amine should also preferably be above ambient temperature in order to ensure a technically simple gas scrubbing process.

For some purposes bifunctional amines can particularly be suitable for gas scrubbing. Examples of such amines are amines of the structural formula R^{a}R^{b}—N—X—N—R^{a′}R^{b′}, with R^{a}, R^{b}, R^{a′} and R^{b′} being selected independently of each other from the alkyl groups, aryl groups or aryl alkyl groups and X representing alkylen or aryl alkylen groups.

Particularly suitable are amine compounds which are selected from a five-membered or six-membered heterocyclic compound and have one NH group in the ring. Preferred heterocyclic compounds are piperazine or piperazine derivatives. Examples of suitable piperazine derivatives are 2-methyl piperazine, N-methyl piperazine, piperidine or morpholine. In fact, however, all piperazine derivatives that are soluble in water and reasonably priced are suitable as amine compounds for the extraction. The presence of amines leads to a considerable increase of the absorption velocity and thus the capacity of absorbing carbon dioxide in the aqueous ammonia solution for a specified mass transfer coefficient.

Processes for the production of industrial gases which can be scrubbed by the inventive process can, for example, be coal gasification processes, steam reforming processes, coke oven gas production processes, refinery gas treatment processes or natural gas production processes. However, the processes can, in principle, be of any type provided they contain acid gas and particularly carbon dioxide on account of their nature. This solvent combination is particularly suitable for the removal of CO₂ from flue gases. An also particularly suitable use for the inventive solvent combination is a coke oven gas. The acid gases to be separated are particularly hydrogen sulphide, carbon dioxide, hydrocyanic acid, mercaptans, carbonyl sulphide (COS), sulphur oxides (SOₓ) or a mixture of theses gases. The gas generated can contain nitric oxides. The inventive solvent combination is insensitive to nitric oxides and oxygen and has a long service life.

The amine should have a concentration of 0.001 to 50 mass percent when being used in the absorption solution. Particularly suitable are concentrations of 0.1 to 20 mass percent. The ammonia solution to be used should have a concentration of 0.1 to 32 mass percent. Particularly suitable are ammonia concentrations of 10 to 25 mass percent. The concentration of the solvent constituents depends on the temperature and pressure applied.

The aqueous ammonia solution is directly added to the amine, thus forming a solution suitable for absorption. Depending on the pH value the ammonia can also be added in the form of an ammonium salt. Ammonium carbonate, for example, is a suitable ammonium salt.

For running the gas scrubbing process all devices are suitable which are suited for gas scrubbing. Devices suitable for running the inventive process include at least one gas scrubbing column. Used as gas scrubbing columns are, for example, columns with regular/irregular packings, tray columns and other absorbers such as membrane contactors, radial-flow scrubbers, jet scrubbers or Venturi scrubbers. Added to these are all devices suitable for the regeneration of the scrubbing solution by removing the carbon dioxide contained in the scrubbing solution. These include, for example, pre-heaters, flash vessels, stripping columns, evaporators, condensers or re-absorbers.

The process is run at conditions normally applied in gas scrubbing processes. Preferred process conditions for the removal of carbon dioxide from flue gases are temperatures from 20° C. to 100° C. and pressures from 0.5 bar to 100 bar.

Preferred process conditions for the regeneration of the scrubbing solution are temperatures from 80° C. to 200° C. and pressures from 0.1 bar to 20 bar. Depending on the requirements the applied temperatures may also be lower or the applied pressures higher.

The invention has the advantage that it refers to a process with a high absorption capacity for acid gases and particularly for carbon dioxide. The inventive solvent combination is cheap and can be used easily. By the higher absorption capacity with reference to carbon dioxide it is possible to significantly increase the amount of acid gas absorbed while considerably reducing the amount of circulated solvent. On account of its stability/insensitivity to oxygen and nitric oxides, the inventive solvent combination has a long service life in gas scrubbing processes such that there is a low replenishment need for fresh solvent and a low number of solvent regeneration devices required.

1. Scrubbing solution for the removal of acid gas constituents from industrial gases, the gas flow being brought into contact with a liquid absorption agent in a suitable scrubbing device, comprising:
the liquid absorption agent is an aqueous solution containing ammonia and at least one amine, and
the amine does not contain any hydroxy alkyl substituents in the molecule.

2. Scrubbing solution according to claim 1, wherein the amine is a primary or a secondary amine.

3. Scrubbing solution for the removal of acid gas constituents according to claim 2, wherein the primary amine compound has the general formula H₂N—R^{a}, with R^{a} being selected from alkyl groups, aryl groups or aryl alkyl groups.

4. Scrubbing solution for the removal of acid gas constituents according to claim 2, wherein the secondary amine compound has the general formula R^{a}—N(H)—R^{b}, with R^{a} and R^{b} being selected independently of each other from alkyl groups, aryl groups or aryl alkyl groups.

5. Scrubbing solution according to claim 4, wherein the secondary amine compound is selected from diethyl amine, dipropyl amine or diphenyl amine.

6. Scrubbing solution for the removal of acid gas constituents according to claim 2, wherein the amine compound has the general formula R^{a}R^{b}—N—X—N—R^{a′}, R^{b′}, with R^{a}, R^{b}, R^{a′} and R^{b′} being selected independently of each other from alkyl groups, aryl groups or aryl alkyl groups and X representing an alkylen or aryl alkylen group.

7. Scrubbing solution according to claim 1, wherein the amine compound is selected from a five-membered or six-membered saturated heterocycle with at least one NH group in the ring.

8. Scrubbing solution according to claim 7, wherein the amine compound is selected from piperazine or a piperazine derivate.

9. Scrubbing solution according to claim 1, wherein the ammonia is used in the form of an ammonium salt.

10. Use of a scrubbing solution according to claim 1 for a process for the absorption of acid gases from industrial gases to be treated, wherein the solution has an amine concentration of 0.001 to 50 mass percent and an ammonia concentration of 1 to 32 mass percent.

11. Use of a scrubbing solution according to claim 1 for a process for the absorption of acid gases from industrial gases to be treated, wherein the solution has an amine concentration of 0.1 to 20 mass percent and an ammonia concentration of 10 to 25 mass percent.

12. Use of a scrubbing solution according to claim 10, wherein the industrial gas to be treated is synthesis gas, natural gas, lower alkanes and alkenes, carbon monoxide or hydrogen or a mixture of these gases.

13. Use of a scrubbing solution according to claim 10, wherein the industrial gas to be treated is a flue gas.

14. Use of a scrubbing solution according to claim 10, wherein the industrial gas to be treated is a coke oven gas.

15. Use of a scrubbing solution according to claim 10, wherein the gases to be separated are hydrogen sulphide, carbon dioxide, hydrocyanic acid, mercaptans, carbonyl sulphide or sulphur oxides or a mixture of these gases.

16. Use of a scrubbing solution according to claim 10, wherein the solution used in the absorption has an applied temperature of 20° C. to 100° C. and an applied pressure of 0.5 bar to 100 bar.

17. Use of a scrubbing solution according to claim 10, wherein the solution used in the regeneration has an applied temperature of 80° C. to 200° C. and an applied pressure of 0.1 bar to 20 bar.
